(19) United States
(12) Patent Application Publication
(10) Pub. No.: US 2002/0038311 A1
(43) Pub. Date: Mar. 28, 2002

(54) Reminscence data base system and media recording reminiscence support program

(76) Inventor: Yasuhiro Osugi, Hiroshima Prefecture (JP)

Correspondence Address: BROWN PINNISI & MICHAELS, 400 M & T BANK BUILDING, 118 NORTH TIOGA ST, ITHACA, NY, 14850

(21) Appl. No.: 09/884,360

(22) Filed: Jun. 19, 2001

(30) Foreign Application Priority Data
Jun. 19, 2000 (JP) 2000-182358

(51) Int. Cl. G06F 17/30

(52) U.S. Cl. 707/104.1; 707/9; 707/3

(57) ABSTRACT

A database system for reminiscences, having a question text format storage mechanism 1 which has stored question text formats which are question texts which stimulate/ prompt a user's reminiscence and contain a variable component having attributes and a telecommunications mechanism 2 which outputs question texts to users and obtains replies to question texts from the previously mentioned users, a response storage mechanism 3 which creates and stores a data base of replies to the previously mentioned question texts together with attributes of the previously mentioned replies, a question text generating mechanism 4 which reads question text formats from the previously mentioned question text format storage mechanism, reads responses which match variable component and attributes of this question text format from the previously mentioned response storage mechanism 3, fill these read responses in variable components which match attributes of question text formats, generating question texts and outputting to the previously mentioned telecommunications mechanism 2 and a response outputting mechanism 5 which converts responses made into data bases by a response storage mechanism into a specified format and outputs them.

### FIELD OF THE INVENTION

This invention concerns a reminiscence data base system and media recording reminiscence support programs, particularly a reminiscence data base system and media recording reminiscence support program which elicits a person's recollections of the past, which organizes an emotional record of the influences upon a person until the present which can be viewed and enables a third party to utilize the recollections elicited.

### BACKGROUND OF THE INVENTION

Mental care is important in the relief of stress and dealing with dementia. Current information about patients is central to the information that physicians, caregivers and the like can obtain concerning patients requiring mental health care. For example, such things as the amount that one currently smokes or the amount of alcohol that one consumes, desires for a dignified death and wishes about how to be informed about having cancer.

However, how a patient has lived until now, that is to say, knowing the past, is a powerful key to caring for the mental health of a patient. On the other hand, it is difficult to know the underlying past mental background of a patient in diagnosis in a short period by physicians and caregivers and it is difficult for them to embark upon suitable rehabilitation for each patient.

In addition, in the present state of affairs music therapy and the retrospective method are advocated and they are begun by trial and error by care facilities, but data for individual patients is not available and in order. Thus there is a tendency for different levels of therapy to develop with different caregivers.

### SUMMARY OF THE INVENTION

The invention is a reminiscence data base system for prompting and storing a person's reminiscences, creating data bases of a person's past mental history to encourage mental health and the prevention of mental problems and dementia by persons themselves. These data bases may then be used in the treatment of patients by physicians and caregivers.

The invention provides a question text format storage mechanism which has stored question text formats—question texts which stimulate or prompt a user's reminiscence and contain a variable component having attributes—and a telecommunications mechanism which outputs question texts to users and obtains replies to question texts from the users.

A response storage mechanism creates and stores a data base of replies to the question texts together with attributes of the replies. There is also a question text generating mechanism which reads question text formats from the question text format storage mechanism, reads responses which match variable component and attributes of this question text format from the response storage mechanism, fills these read responses in variable components which match attributes of question text formats, generates question texts and outputs them to the telecommunications mechanism.

In addition, the invention has a response outputting mechanism which converts responses made into databases by the response storage mechanism into a specified format and outputs them.

The previously noted attributes may be indicated by XML tags, and the response storage mechanism may make the user responses into data bases as XML files.

The reminiscence data base system of the invention may be outfitted with a response output control mechanism, which obtains from the user an indication of whether to permit or not permit disclosure of responses stored in the response storage mechanism, and only passes responses to the response output mechanism for which disclosure has been authorized. Optionally, this indication may be restricted to certain parties, and with respect to requests from those parties authorized for disclosure, the control mechanism only passes responses for which disclosure has been authorized for that party to the response output mechanism. This response output control mechanism may control the authorization of whether or not to disclose in attribute units linked to the pertinent response.

The question text generating mechanism may be such that it selects differing question text formats corresponding to responses expressing the emotional level of a user from among the responses stored in the response storage mechanism.

The reminiscence data base system may be outfitted with a multi-media linking mechanism which stores such things as maps, photographs, music or the like which a user chooses, corresponding to the response in a response storage mechanism, in association with the attributes of this response.

The reminiscence data base system can optionally be outfitted with a comment receiving mechanism which receives comments from a party, other than the user, who has obtained a response output from the response output mechanism. The comment might concern that response or the person making the response. A comment storage mechanism is provided which stores the comment in association with the person making a response. The response outputting mechanism converts the comment, in addition to the response, into a specified format, and outputs it.

### BRIEF DESCRIPTION OF THE DRAWING

FIG. 1 is an overall block diagram containing the reminiscence data base system of this invention.

FIG. 2 is a flow chart of user registration processing.

FIG. 3 is a flow chart from the initiation to the termination of service.

FIG. 4 is a flow chart of the processing of creating one's personal history.

FIG. 5 is a flow chart of review processing.

FIG. 6 is a flow chart of the process of disclosing information.

FIG. 7 is a chart showing the flow of stages of questioning and responding, which illustrates a detailed preferred embodiment of this invention.

FIG. 8 is a chart showing the flow of stages of selection of questions, which illustrates a detailed preferred embodiment of this invention.

FIG. 9 is a chart showing the flow of the stages of disclosure of information, illustrating a detailed preferred embodiment of this invention.

FIG. 10 is a chart showing the flow of stages of utilizing disclosed information illustrating a detailed preferred embodiment of this invention.

### DETAILED DESCRIPTION OF THE INVENTION

A preferred embodiment of the invention will be explained in the following with reference to drawings.

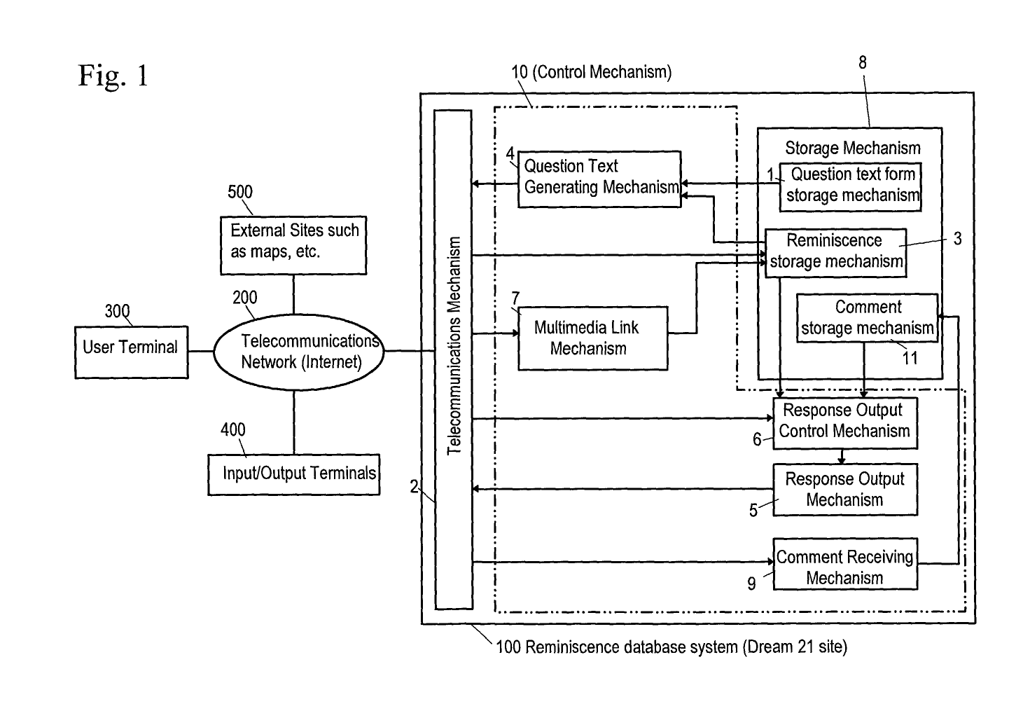

FIG. 1 is an overall block diagram containing the reminiscence data base system 100 of this invention. The reminiscence data base system 100 (Dream 21 site), a user terminal 300, output end terminal 400, externally linked sites 500 such as maps etc. are connected to a telecommunications network 200 such as the Internet.

The reminiscence data base system 100 comprises question text format storing mechanism 1 which stores question text forms—question texts which stimulate or prompt a user's reminiscence, with variable components having attributes. Telecommunications mechanism 2 outputs the question texts to a user, and obtain responses to question texts from such users. It also has a response storage mechanism 3, which creates a data base and stores responses to these questions and the attributes of these responses.

A question text generating mechanism 4 reads question text forms from question text form storage mechanism 1, reads responses whose attributes match the variable component of the question text forms from response storage mechanism 3, and fills in this response in variable components which match the attributes of a question text form. The mechanism thus generates a question text, and outputs the text to telecommunications mechanism 2. Response output mechanism 5 converts responses which have been placed in data bases by response storage mechanism 3 into a specified format and outputs them.

In the preferred embodiment, the attributes are indicated by XML (eXtensible Markup Language) tags, and response storage mechanism 3 enters user's responses in data bases as XML files.

Output control mechanism 6 obtains a directive whether or not to permit disclosure concerning a response stored in response storage mechanism 3, and only permits responses to be passed to response output mechanism 5 for which disclosure has been authorized. An attribute unit linked to a given response controls whether or not to authorize disclosure.

In addition, the question text generating mechanism 4 is designed to select question text forms which differ, corresponding to responses expressing the emotional level of a user from among the responses stored in response storage mechanism 3.

A multimedia linking mechanism 7 stores data for maps, photographs or music, etc. A user selects data corresponding to a response in response storage mechanism 3 in connection with the attributes of this response.

Reminiscence data base system 100 is equipped with comment receiving mechanism 9, which receives comments concerning a given response or the person responding with this response, and a comment storing mechanism 11 which stores this comment in connection with the person responding (user). Response output mechanism 5 is equipped with a feature which, in addition to the users response, converts the comment stored in comment storage mechanism 11 to a specified format and outputs it.

To explain this in even greater detail, question text form storage mechanism 1, response storage mechanism 3 and comment storage mechanism 11 are provided in this embodiment as a storage area of storage mechanisms 8 which might be a hard disk drive (HDD) etc. Question text generating mechanism 4, response output mechanism 5, response output control mechanism 6, multimedia link mechanism 7 and comment receiving mechanism 9 are processes realized by control mechanism 10 executing reminiscence support programs. This control mechanism 10 is equipped with a central processing unit (CPU) which executes program processing. Telecommunications mechanism 2 is a modem for connecting a telecommunications network.

Reminiscence support programs are stored on computer readable media, and cause a computer to output question texts to a user, process the responses to questions obtained from a user, perform processing which places responses to these questions together with the attributes of these responses in a data base and stores them in response storage mechanism 3, perform processing which reads question text forms from question text form storage mechanism 1 and reads responses for which the variable component and the attributes of this question text form match from response storage mechanism 3, apply this response which has been read to a variable component which matches attributes of a question text form and outputs it to telecommunications mechanism 2.

User terminal 300, which is connected to telecommunications network 200, utilizes reminiscence data base system 100 and is such things as a personal computer system of one who creates one's own reminiscence data base. Output terminal 400 is such things as a a physician or other caregiver's personal computer system which utilizes individuals'reminiscence data bases created in reminiscence data base system 100. Maps, etc., external site 500 is built on a server device equipped with an Internet content server.

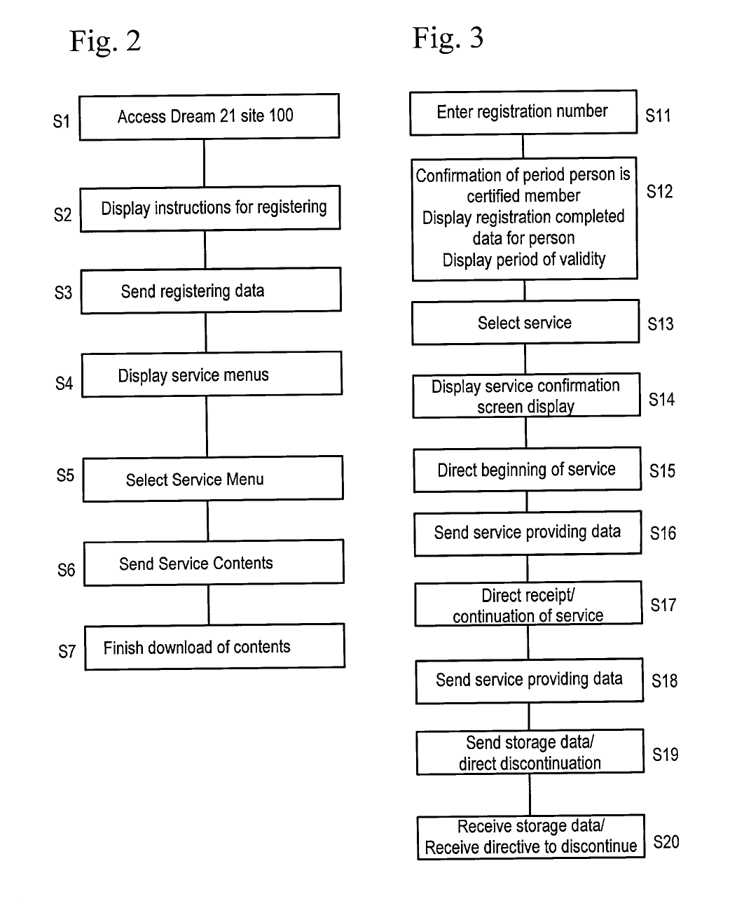

Next we shall explain the operation of this embodiment based on the flowcharts in FIGS. 2 through 6.

Users who utilize this system register from a user terminal 300. FIG. 2 is a flow chart of user registration processing.

Users access reminiscence data base system (Dreams site 21) 100 from user terminal 300 in step (S1). Dream 21 site 100 sends instructions for user registration to user terminal 300 and causes them to be displayed (S2). A user confirms these instructions and sends data for registration to Dream 21 site 100 (S3). Dream 21 site 100 executes user registration processing and after completion of registration sends a menu of services to user terminal 300 and displays it (S4). When a user selects a service menu (S5) Dream 21 site 100 causes the content (front page) of the selected service to be displayed on the user's terminal (S6, S7).

Next we shall explain the flow from the initiation of service to its termination based on FIG. 3.

A user who has finished registering enters his or her own registration number for Dream 21 site 100 from a user terminal (S11). Dream 21 site 100 verifies whether or not the person is a user who completed registration based on the registration number entered. If the person has completed registration, it sends his or her registration data and the effective period that he or she can receive service to user terminal 300, and causes it to be displayed (S12). The effective periods for individual members is managed by storage mechanism 8. Next, a user selects the service he or she wishes to receive (S13) and enters it in Dream 21 site 100. Dream 21 site 100 sends a display screen for confirming input of service selected to user terminal 300 and causes it to be displayed (S14). In response to this a user directs service to begin if the selected service is correct (S15). When service is begun by direction of the user, Dream 21 site 100 begins sending service providing data such as question texts to the user terminal 300 (S16, S18). User terminal 300 receives service providing data and displays it. A user can direct Dream 21 site 100 to send data such as responses to question texts or to continue or discontinue service (S17, S19). Dream 21 site 100 receives such things as responses, etc., sent from user terminals and stores and accumulates them in storage mechanism 8. In addition, when directed to discontinue service by a user it will discontinue providing server to that user terminal 300 (S20).

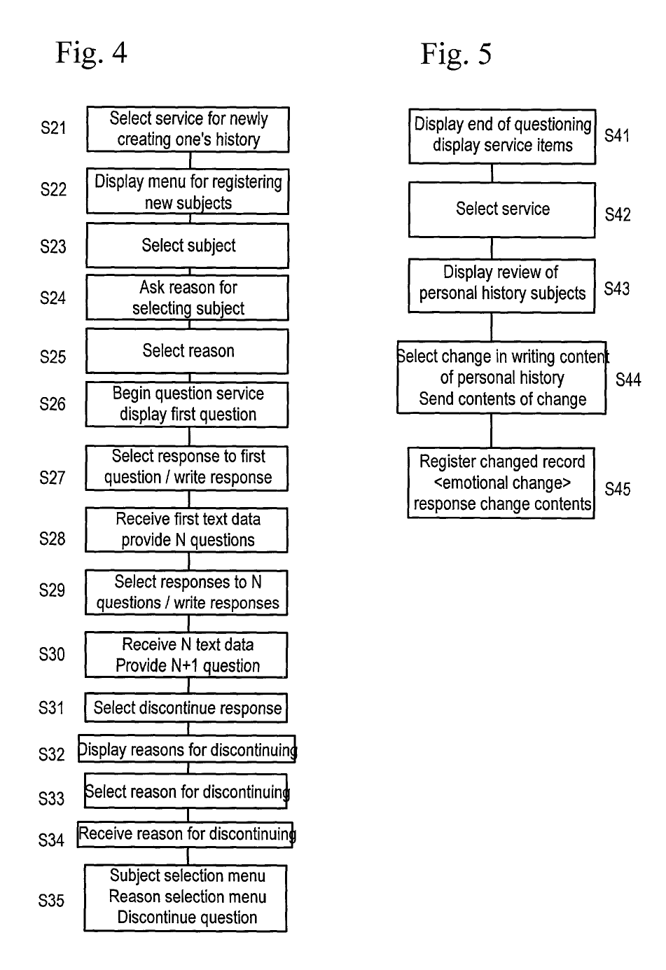

Next we shall explain the service of creating a personal history, which is one of the services offered by Dream 21 site 100. FIG. 4 is a flow chart of the processing of creating one's personal history.

When a user selects to create a new personal history (S21), control mechanism 10 sends a list of categories and subjects to be created to a user terminal 300 and requests selection of subjects (S22). Here the categories for creating one's personal history are such things as “family,” “work,” “academic studies” etc. Categories and subjects will be discussed in detail in the example discussed below.

When a user selects a new subject (S23), control mechanism 10 records the subject selected in the file for that user in response storage mechanism 3. Further, control mechanism 10 asks the user why he or she selected that subject (S24). When the user posts a reason for selecting that subject (S25) control mechanism 10 records that reason in the file for that user in response storage mechanism 3. Then a question text following that subject that the user selected (in this embodiment read in page units) is read from question text form storage mechanism 1 by question text generating mechanism 4 and that primary question is sent to and displayed on the user's terminal 300 (S26).

A user selects a response for the primary question or writes a response and sends the response to Dream 21 site 100 (S27). Control mechanism 10 links the attributes of that response to the response received from the user and records them in this user's file in response storage mechanism 3. Then control mechanism 10 repeatedly asks a user questions while altering the question text with a 2^{nd} question, 3^{rd} question . . . N^{th} question (N is a positive integer), and successively records these responses and corresponding attributes in response storage mechanism 3 (S28, S29, S30).

In this process, question text generating mechanism 4, when a variable component of attributes is contained in a question text form, reads responses which match these attributes from response storage mechanism 3 and applies them to the variable component and after it completes a question text sends it to user terminal 300.

For example, in advance question texts it asks the user for past “nicknames” and records those “nicknames” as the attribute <who>. Then if there is a question text which has the variable component of attribute <who> in subsequent question texts, it applies a response which matches the attributes of that variable component, that is to say the previously noted “nickname,” and completes the question text.

When a user indicates that he or she wishes to discontinue during questioning (S31), control mechanism 10 sends a list of options for reasons for discontinuing to user terminal 300 and causes it to be displayed (S32). When a user selects a reason from the list of reasons for discontinuing, control mechanism 10 records that reason for discontinuing in that user's file in reminiscence storage mechanism 3 and discontinues questioning (S34).

When the questioning for one subject has been completed through to the end, the process transitions to the processing of FIG. 5.

When questioning has been completed through to the conclusion, control mechanism 10 sends a questioning completed message to a user's terminal and causes it to be displayed. In addition, control mechanism 10 send a list of service items to the user's terminal and causes it to be displayed (S41). When a user selects personal history subject review for the list of service items, control mechanism 10 reads the responses until now from that user's file in reminiscence storage mechanism 3 and sends them to a user's terminal and causes them to be displayed (S43). A user can modify his or her responses to date, which are displayed.

Users who have finished modifying responses send modified responses to Dream 21 site 100 (S44). Control mechanism 10 accepts modified responses, maintains the responses prior to modification “as is”, and stores modified responses in association with the attribute <change of feelings> in reminiscence storage mechanism 3 (S45).

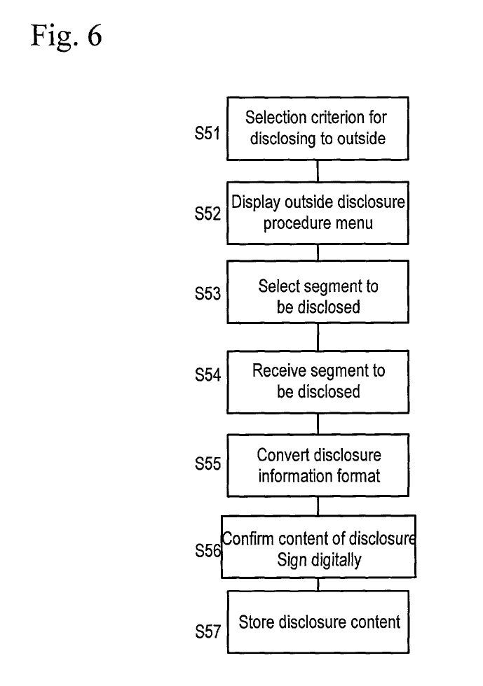

Next, we shall explain the method of a user disclosing one's responses to an outside party. FIG. 6 is a flow chart for disclosure processing.

A user may select disclosure standards that have been established in advance, and view them. When control mechanism 10 is requested to permit viewing of disclosure standards it sends disclosure standards to a user's terminal 300 and causes them to be displayed. In addition, it sends a selection menu, which follows disclosure procedures to a user's terminal 300, and causes it to be displayed.

A user can select a disclosure segment from the selection menu of disclosure procedures, specifying portions of responses to the questions which one will permit to be disclosed to outside parties. The portion which is authorized for disclosure can be done in attribute units of responses.

A user selects the portions that he or she will allow to be disclosed to an outside party from among responses to questions in attribute units of these responses and sends them to Dream 21 site 100 (S53). Control mechanism 100 which accepts selections of attributes which have been authorized for disclosure by a user (S54) extracts only the response of the attribute for which disclosure has been authorized from that user's files stored in reminiscence storage mechanism 3, converts the extracted response to a format for disclosing information specified in advance (chart form, personal history publishing form etc.) and sends converted files to a user's terminal 300 (S55).

A user views a converted file received from Dream 21 site 100, and if there is no problem with the content to be disclosed, makes a digital signature on that converted file and sends and returns it to Dream 21 site 100 (S56). Control mechanism 10 then stores the converted file with a digital signature in a recording area which an outside party (sending terminal 400) can access (S57)

Next we shall present a detailed example of the preferred embodiment based on the foregoing preferred form of embodiment.

First, we are considering the following as categories and subjects for creating the previously noted personal history:

Categories: family, work, academic studies, hobbies, romantic love, friends, hometown, incidents etc.

The following subjects appertain to their respective categories.

1) Subjects appertaining to category “family”:

From roots to birth <antecedents>

Development of consciousness of oneself

Becoming independent from parents

Separation from family members

Brothers/Sisters

Children

Married couple

Concern for family

2) Subjects appertaining to category “work”:

Period as new employee

Period as newly dispatched employee

Period as mainstay of company

Period in managerial positions

Period in administration

Autonomous period

Semi-retirement

Semi-employed

Retirement

Unemployed periods

Part-time employment periods

Work after retirement

3) Subjects appertaining to category “academic studies”:

Primary school period

Middle school period

High school period

Undergraduate, graduate, junior college, vocational school period

Correspondence course period

Life education

4) Subjects appertaining to category “hobbies”

Encounter

Qualifications

5) Subjects appertaining to category “romantic love”:

First love

Grief

Unrequited love

Marriage

Immorality

6) Subjects appertaining to category “friends”:

Close friends

Quarrels

Parting ways

7) Subjects appertaining to category “hometown”:

People

Home

History

8) Subjects appertaining to category “Incidents”:

Travels

Divorce

Sicknesses

Hospital life

Accidents

Work assignment separated from family

War

Death of a loved one

Bankruptcy

Awards

Other

Next, we shall show the question texts which appear in the procedure for creating a personal history and some concrete examples of some responses.

In the following, questions will be indicated by “Q” and responses by “A.” Transmission and receipt of questions and responses between user terminals 300 and reminiscence data base system 100 are performed in page units. {xxx} indicates the portion applied to the variable component of a question text form which has attributes matching the response selected from response storage mechanism 3. <xxx> indicates the attributes (XML tag) of a response. (xxx) means the response that the user wrote.

The flow of questions has four types of patterns in a single subject. Selection of patterns is done based on emotional levels of users, which are specified from previous responses. As used here the term “emotional level” means the degree to which the feelings that a user has concerning a certain subject are good feelings (good impression) or bad feelings (a negative impression).

When the user has positive feelings concerning a subject that he or she has picked, a G1 or G2 pattern question text, which will be explained later, is used. On the other hand, when a user has negative feelings about a subject selected, a B1 or B2 pattern question text is used. Questions that have a common pattern are expressed by <<xx>>.

A user marks the response he or she has chosen with a dot (●). A user indicates a response he or she describes for questions to which he or she describes the response by placing the response in parentheses ( ). The procedure shown below is executed by program processing of control mechanism 10, and a user's response is recorded in response storage mechanism 3.

The sample below is one in which a user selects <work> as the category and selects <period as a new employee> as the subject under that category. By selection of this subject the three attributes of (1) <became employee of company> (2) <trained > and (3) <worked> are automatically created. In the following explanation, these three attributes will be abbreviated by the number which precedes them in parentheses.

<<Common question pattern>>

(note) First, it begins with common question pattern. An “Interview register” button, “Redo” button, “Registration completed confirm contents” button, and a “Wish to answer each question later” button are displayed on the screen of user terminal 300.

When the “Would like to answer later” button is pushed in succession for 3 or more question screens, control mechanism 10 causes a warning to be displayed on user terminal 300—the content of the warning is something such as “Let's do the interview later” or “Shall we cancel selection of subjects” etc. It warns of the possibility that there may be an undesirable effect on one's mental state.

### A Sample Session

[Q1/ A1] The “new employee” which you selected refers to your experience, doesn't it?

Selection ● Yes ∘ No

(Note) Here when the response is “Yes,” the response is registered with the respective attributes to attributes (1), (2) and (3) as <who>. When the response is “No”, the message which indicates the category change to “family” is displayed.

[Q2/ A2]

(1) The new employee period of the {you} in your memory appears as what image to you now?

∘ Somber ∘ Gray ∘ Difficult ● Nostalgic ∘ Rose-colored ∘ Dazzling

(Note) This response is recorded in attributes <replay record> and <social requirement >. Subsequent question text patterns are selected depending on whether the three responses on the left side or the three responses on the right side are chosen, and the color of the background and color of the characters displayed to the user's terminal change from the next screen. The color of the background may be allowed to change with different categories. For example, with this response, it is set so that the background color is a light sepia and the color of the characters are black.

(2) At that time what name were you called by people who were close to you? For example, oo-san, oo-chan, oo-kun, oo-etc. We would like to use it in these questions we will be asking to recall your recollections of that period. I think I was called (xx-kun) at that time.

(Note on example) “-san” is the Japanese honorific, similar to “Mr.” or “Mrs./Ms” in English. “-chan” is used for small children, and “-kun” for boys (similar to the English “Master”), or for young men by a superior to a subordinate. Thus, the response “Osugi-san” would be equivalent to “Mr. Osugi”. “xx” is intended to represent the name input by the user.

(Note) Decide on the name to be called henceforth and record the data in association with the specified attributes in reminiscence storage mechanism 3. This information will be maintained insofar as it does not change due to the subject cancel button or the name to be called change button appearing on or after the next page.

(3) Is it all right to call you by the name you were called then in this questioning?

● Yes ∘ No (We will call you “you”)

Now then we are going ask a number of question so please relax and tell me.

(Note) In subsequent Q & A pages, five additional buttons will be displayed in addition to Q & A (Including the previously noted 3 buttons, there will be a total of 8 buttons): (1) name to be called change button, (2) discontinue interview button (A screen will be displayed for selection of whether to save data or to cancel this subject itself and delete all data will be caused to be displayed when this button is pushed), (3) Store image/ map/ music/ moving picture data button, (4) Start/stop background music button and (5) Help

<<G1, G2>> common:

We would like in particular to hear about the time up until you joined the company, the very important period in terms of {xx-kun's} life when you embarked upon becoming a full fledged member of society and your experiences after you joined the company. Close your eyes, take a deep breath, forget about the you of the moment and try to return to the you of the past temporarily.

[Q3/ A3]

(1) How old were you at the time of the <nostalgic> new employee period in {xx-kun's} memory?

It was when I was (23) years old.

(Note) Record the response as attribute <when> under the respective attributes (1), (2) and (3).

(2) Did the place where you had lived until then change when {xx-kun} joined the company?

● Yes. Prior to joining the company I lived in ( Tokyo ) ∘ No

(Note) Record response as attribute <where> under attribute (1).

(3) Please tell me the name of the company {xx-kun} joined and where {xx-kun} began working.

The name of the company was (yyy Ltd.) and the location was (Nagano).

Here in order to recall the past click the address of your residence and the location of the company prior to joining the company with the map button and try to search for them. When you find them attach the name and store them please.

(Note) The map button either links to Web content of map site 500 and searches for a map, stores named file and stores the pertinent image or stores the URL. The response “yyy Ltd.” “Nagano” is recorded as attribute <where> under attribute (1). In addition, multimedia link mechanism 7 registers the map image storage address or the URL of the map image as attribute <reconfirming record> under respective attributes (1), (2) and (3).

[Q4/ A4]

(1) Was {yyy Ltd.} {xx-kun}'s first choice?

∘ Yes ● No

(Note) Register response as attribute <why> under attribute (1).

(2) What was the occasion for you deciding to work for {yyy Ltd.} in {Nagano}?

∘ I somehow felt that it would be right for me.

● I felt that it seemed that I could do what I wanted there.

∘ Recommended by teacher

∘ Recommended by relative

∘ They had a good reputation

∘ Seemed to have a future

∘ Recommended by upperclassman

∘ Good locational condition of the company

∘ Upperclassmen and acquaintances were there.

● Other (I thought it seemed interesting since it was a company to which Corporate Reorganization Law applied)

(Note) Record the response as attribute <why> under attribute (1)

(3) What kind of a company was {yyy Ltd.} in {Nagano}? For example, tell me what you can remember about the number of employees, some of the representative goods it handled, how much were the sales, its customers and the main factory etc. {yyy Ltd.} ( has its headquarters in ** ward ** in Tokyo, had about *** employees, manufactured such things as electrical generators, switches, large and small motors etc. and was a company which sold to the *** market. Its factory was in *** Nagano prefecture. I think their sales were about ** billion at the time I joined the firm.)

(Note) Record the response as attribute <where> under attribute (1).

(4) What did {xx-kun} do at the time you took the entrance exam for {yyy Ltd.}? For example, did you visit the company, gather materials about it, or suffer hardships in some way? Please tell me what you remember was your impression at the time you took the company entrance examination. For example, when you were baffled by an intimidating question or you responded in a manner out-of-character to the way you usually are. At the time I took the entrance examination for {yyy Ltd. } (I had only visited the company once. I remember that at that time that rather than asking about the present state of the company I asked the Chief of the General Affairs Section why the company was being reorganized under the Corporate Reorganization Law. There were comments such as careless management etc. I think there were 3 people who interviewed me and I recall that I honestly answered that my reasons for wanting to join the company was that it seemed interesting that it was a company subject to the Corporate Reorganization Law and that I felt that it seemed that I could do what I wanted there.)

(Note) Register response as <how> under attribute (1).

0[Q5/ A5]

(1) Do you still have photographs, video tapes, records etc. that are mementos that would recall you at that time?

● I do. (Photograph of when I graduated.)

∘ I don't recall particularly.

Will {xx-kun} digitally register it as material of this subject later?

● Yes. ● Photographs ∘ Video tapes ∘ Music ∘ Other

∘ No.

(Note) Multimedia link mechanism 7 registers the storage address of photograph data as attribute <reconfirm recollection><photograph> under attribute (1) as unregister items.

(2) What kind of a time do you think it was when {xx-kun} joined {yyy Ltd.}? Please refer to topics of this period and select what impressed you. Please try to refer to link pages for items that you find interesting. Push the chronology button for that period and try to select the items that impressed you.

(Note) Causes chronology screen to be displayed on user terminal 300 and allows user to select items on the chronology. Record the selected items as attribute <emotional background><social background> under respective attributes (1), (2) and (3).

[Q6/ A6]

(1) How do you think the matters selected affected the way {xx-kun} thought at that time? ( )

(Note) Here the information concerning the matters that the user selected in the chronology in the response to the previous question are displayed as is on the screen of the user's terminal. The answers are registered as attribute <emotional background><social background>.

(2) At that time what were the things that {xx-kun} became totally involved in and what were your hobbies? ( )

(Note) Register response as attribute <self-demand><realize demand>.

(3) At that time did {xx-kun} continue the life of a student and not become a full fledged adult and did you not have the financial resources to live as you like?

∘ Did not. (What I could not continue was)

∘ Had. (What I did not continue was)

(Note) Register response as attribute <emotional background><financial reason>.

(4) At that time was there a person that {xx-kun} had romantic feelings about? How did you think you would tell this person that you were going to {join a company}? Also please try to recall what you did.

( )

(Note) Register response under attribute (1) as attribute <emotional background><personal relationships>.

(5) At that time what were {xx-kun}'s family and other people around you, for example, upperclassmen, teachers etc. saying about you joining {yyy Ltd.} in {Nagano}?

( )

(Note) Register response under attribute (1) as attribute <emotional background><personal relationships>.

(6) In looking back on those times please tell us about anything that that you were especially scrupulous about.

∘ I don't recall anything in particular.

● At that time I was particular about ( ).

(Note) Register response under attribute (1) and (20 as attribute <emotional background><other>.

[Q7/ A7]

(1) Prior to {xx-kun} joining the company, were there any things that you thought you wanted to realize yourself? For example, when you join {yyy Ltd. } it will quickly begin selling new products, that you will be able to do things that you studied about up until now and things that you could not doing during your life as a student. How did you want to be in this new environment.

( )

(Note) Register response under attribute (1) as attribute <self-demand><realize demand>.

(2) What did {xx-kun} worry about in anticipation of the change in environment? For example, did you worry whether you would be able to get along with a new person older than you or did you worry about what you would do if this new work was not something which suited you?

( )

(Note) Register response under attribute (1) as attribute <self-demand><escape demand>.

(3) What were {xx-kun}'s dreams at this time? Close your eyes and try to look back and think of what your goals/wishes for the future were without being a slave to your work.

My dreams at that time were ( ).

(Note) Register response under attribute (1) (2) and (3) as attribute <self-demand><goal demand>.

(4) With respect to {xx-kun}'s dreams, how did joining {yyy Ltd.} affect them?

● I thought I had made the first step with respect to my dreams at that time.

∘ I did not think that it was an obstacle to my dreams at that time.

∘ I had the feeling that I had encountered a difficult barrier with respect to my dreams at that time.

∘ I felt that I was in a state from which I did not seem to be able recover with respect to my dreams.

(Note) Register response under attribute (1) as attribute <self-demand><goal demand>. Register degree of satisfaction. For example, if response 1 is selected then register satisfaction. If response 2 is selected register relief. If response 3 is selected register anger. If response 4 is selected register distress.

(5) What do you think from the present you about the past you which passed the period of when you were becoming a successful adult member of society emotionally?

● As it were I worked very hard. The me of that period is the basis for the me of now.

∘ It makes me recall the courage and wishes that I could face, that the present me has forgotten and cannot see.

∘ That the past me that did not know anything about the world was pitiful.

∘ If I could redo the past me, I would probably be a different me now.

(Note) Register under attribute (1) as attribute <play record><internal cause><social demand><love>. For example, the first response is registered as love, the second response is registered as jealousy, the third response is registered as shame and the fourth response as hate. When the lower 2 have been selected proceed to G2 pattern question texts.

<<G1 Pattern Questions>>

[Q8/ A8] Now please allow us to ask about things after {xx-kun} joined {yyy Ltd.}.

Forget about prior to joining the company, close your eyes and try to recall the you of the time you joined the company.

(1) Do you remember about the ceremony when you joined the company? For example, what the company president said or that you made new friends where the ceremony was held etc.

∘ Yes.( )

● I don't remember anything in particular.

(Note) Register response under attribute (2) (3) as attribute <emotional background><personal relationships>.

(2) Do you recall how long the company had for a training period or trial period ? {yyy Ltd.} had a period of (180) days for its new employees.

(Note) Register response as attribute <why> under attribute (2).

(3) Where was this done? For example, in the same department or in various departments or at a special training center or at other companies. Please try to think back and remember.

That training was held (in various departments in the factory and at a small training center).

(Note) Register response as attribute <where> under attribute (2).

(4) How did {xx-kun} spend his or her time and what did {xx-kun} think during the training period/ trial period that you think in no small way influenced the way that {xx-kun} performs his or her work nowadays? For example, not just simply absorbing information but such things as learning how the instructors approached work, being shocked by the ideas and experiences of others joining the company at the same time, finding things that one thought he or she wanted to do at this company, struggling to absorb new things but somehow succeeding, making new friends etc. Please tell me what {xx-kun} remembers.

(Note) Register response as attribute <how> under attribute (2).

[Q9/ A9]

(1) Did {xx-kun} gradually begin to see during the training, trial period things that you wanted to realize in working for the company that you had hoped for prior to joining {yyy Ltd.}?

● Yes.

∘ No, the reason is ( ).

(Note) Register response as attribute <self demand><realize demand><wish> under attribute (1).

(2) Were concerns that {xx-kun} harbored prior to joining {yyy Ltd.} gradually resolved during this training period?

● Yes.

∘ No, the reason is ( ).

(Note) Register response as attribute <self demand><escape demand><relief under attribute (1).

(3) Do you still have photographs, video tapes, records etc. that are mementos from the time of your training/ trial period at {yyy Ltd.}?

∘ Yes (graduation photograph)

● No particular recollection

Will {xx-kun} digitally register it as material of this subject later?

∘ Yes. ∘ Photographs ∘ Video tapes ∘ Music ∘ Other

● No.

(Note) Register response as attribute <reconfirm memory><none> under attribute (2)

[Q10/ A10]

(1) During the training/ trial period at {yyy Ltd.}, {xx-kun} encountered new people and what did they all say about {xx-kun}? For example, seems serious, pessimistic, an optimist. Please tell me.

The others around me at that time said that I was ( ). P2 (Note) Register response as attribute <emotional background><personal relationships> under attribute (2).

(2) At that time did new friends or new love interests appear? How do you think these persons influenced you? Are you still in touch with them?

● Yes (During the training/ trial period at {yyy Ltd.} ( )

∘ No

(Note) Register response as attribute <emotional background><personal relationships> under attribute (2).

(3) During the training/trial period at {yyy Ltd.} didn't ideas occur to {xx-kun} of somethings you yourself wanted to realize that you hadn't thought of prior to joining the company? For example, such things as you yourself proposing improvements to the speed of clerical operations that were thought to be unsatisfactory in this company etc.

( )

(Note) Register response as attribute <self demand><realization demand> under attribute (2).

(4) During the training/ trial period at {yyy Ltd.} didn't concerns occur to {xx-kun} of somethings that you hadn't worried about prior to joining the company? For example, such things as being assigned to a department that you were not very interested in etc.

( )

(Note) Register response as attribute <self demand><escape demand> under attribute (2).

(5) With respect to {xx-kun}'s dreams, how did spending the training/trial period at {yyy Ltd. } affect them?

● I thought I had made the first step with respect to my dreams at that time.

∘ I did not think that it was an obstacle to my dreams at that time.

∘ I had the feeling that I had encountered a difficult barrier with respect to my dreams at that time.

∘ I felt that I was in a state from which I did not seem to be able recover with respect to my dreams.

(Note) Register degree of satisfaction as attribute <self demand><goal demand> under attribute (2).

[Q11/ A11] Now then please allow us to ask about things after {xx-kun} finished the training/trial period at {yyy Ltd.}. Forget about the (180) day training/ trial period, and try to recall the you of the time you were properly recognized as an employee and began working.

(1) Where were you assigned? In that department, specifically what sort of work was primarily done? Was it considered by the company to be a major department? I was assigned to ( ) of {yyy Ltd.}.

(Note) Register response as attribute <where> under attribute (3).

(2) What do you think the company expected of {xx-kun} in assigning you to this post? Please tell us and it is all right to imagine, for example, such things as that it was what you desired and that you were close to the type of person needed etc. I think that the reason that I was first assigned at {yyy Ltd.}. was perhaps ( )

(Note) Register response as attribute <why> under attribute (3).

(3) How did you feel about the atmosphere of the department to which {xx-kun} was assigned? Do you recall what {xx-kun} thought of being a member of that department at that time? Did your first impression of your direct superior differ from your later impression of him or her? Please tell us what you recall about what your seniors said etc.

( )

(Note) Register response as attribute <emotional background><personal relationships> under attribute (3).

(4) When {xx-kun} began working at your new post did new friends or new love interests appear? Please tell us if there were.

(Note) Register response as attribute <emotional background><personal relationships> under attribute (3).

(5) When {xx-kun} was assigned I think you persevered while working but do you recall what failures and episodes you experienced concerning your actual work? Please tell us what you learned from these and such things as how these became occasions for gaining confidence in yourself.

( )

(Note) Register response as attribute <how> under attribute (3).

[Q12/ A12]

(1) Were there things that prior to joining {yyy Ltd.} {xx-kun} hoped to try to realize while at the company which you gradually were able to realize while working as a full-fledged member of the company?

● Yes

∘ No. The reason was ( ).

(Note) Register response as attribute <self demand><realization demand><wish> under attribute (1).

(2) Could you gradually make clear things that you wanted to do something about during the training/trial period at {yyy Ltd.} that you hadn't thought of prior to {xx-kun} joining the company more concrete during your time as a new member of the company?

∘ Yes.

● No. The reason is ( ).

(Note) Register response as attribute <self demand><realization demand><wish> under attribute (1).

(3) Did {xx-kun} develop new things you were very particular about which differed from prior to joining the company?

∘ Yes—I became very particular about ( ) after I began working as a regular employee.

● No

(Note) Register response as attribute <emotional background><other>under attribute (3).

[Q13/ A13]

(1) Were things that {xx-kun } felt uneasy about prior to joining the company resolved during this period?

● Yes.

∘ No. The reason is ( ).

(Note) Register response as attribute <self demand><escape demand><relief> under attribute (1).

(2) Were concerns that occurred to {xx-kun} during the training/trial period at {yyy Ltd.} of somethings that you hadn't had prior to joining the company gradually resolved?

● Yes.

∘ No. The reason is ( ).

(Note) Register response as attribute <self demand><escape demand><relief> under attribute (1).

(3) Do you still have photographs, video tapes, records etc. that are mementos from the time you became a new employee at {yyy Ltd. }?

● Yes (xx photograph)

∘ No particular recollection

Will {xx-kun} digitally register it as material of this subject later?

● Yes. ● Photographs ∘ Video tapes ∘ Music ∘ Other

∘ No.

(Note) Register response as attribute <reconfirm recollection><photograph> under attribute (3).

[Q14/ Q14] Here a “Message to oneself” button is added to the screen of the user terminal 300.

(1) With respect to {xx-kun}'s dreams, how did spending the time as a new employee at {yyy Ltd. } affect them?

● I thought I had made a more concrete step with respect to my dreams at that time.

∘ I did not think that it was any sort of an obstacle to my dreams at that time.

∘ I had the feeling that I had encountered an even more difficult barrier with respect to my dreams at that time.

∘ I felt that I was in a state from which I did not seem to be able recover with respect to my dreams.

(Note) Register degree of satisfaction as attribute <self demand><goal demand> under attribute (3).

(2) What does the present “you” think about the “you” who during the time you were becoming a full fledged member of society had numerous and repeated difficulties, despair and wishes?

● As it were I worked very hard. The me of that period is the basis for the me of now.

∘ It makes me recall the courage and wishes that I could face, that the present me has forgotten and cannot see.

∘ That the past me that did not know anything about the world was pitiful.

∘ If I could redo the past me, I would probably me a different me now.

(Note) Register under attribute (1) as attribute <play record><internal cause><social demand><love>.

Thereby the interview of {xx-kun}'s {new employee period} is finished. You must be tired. As the last item, please write in the title of this interview. For example, something such as “A New Departure” etc. After a while, try reading it over. You may read it over and correct it. When everything is finished press the message button and try sending a message from the present you to the past you. Then try sending a message from the past you to the future you. Interviews will be repeated any number of times and can be done from now on. Set aside time and please be interviewed on this subject again. The interview we have done today can be seen anytime and until anytime insofar as {xx-kun} does not erase it. You can probably discover how you are changing by repeating the interview. Dream 21 will always watch out for {xx-kun}.

### End of Sample

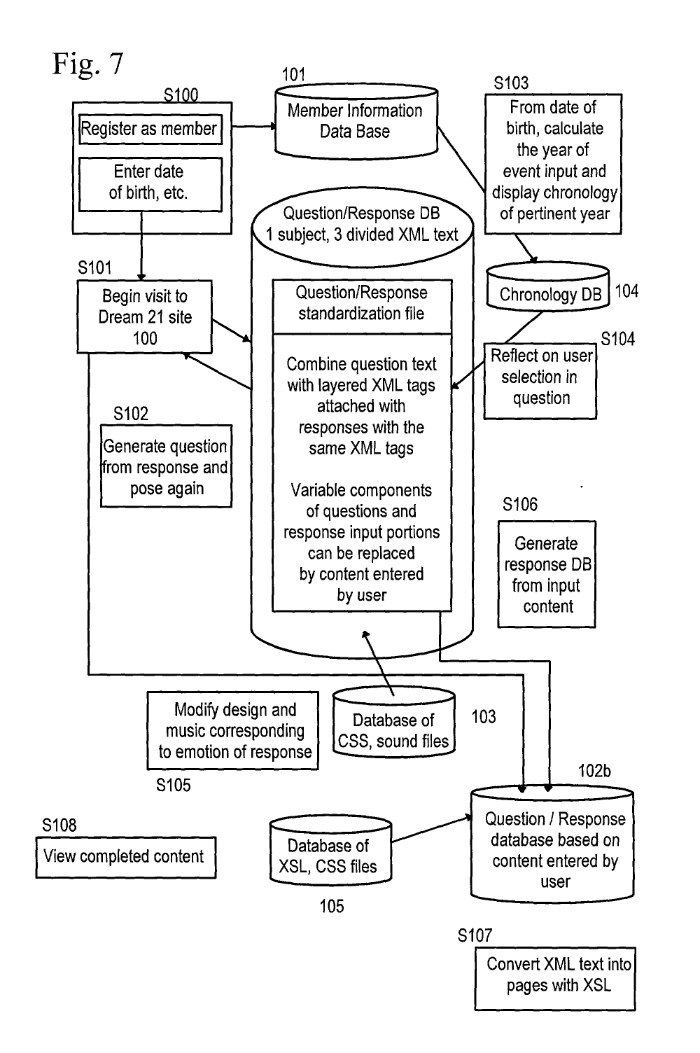

Next, an embodiment of the invention based on FIG. 1 and FIGS. 7 through 10 will be described in detail.

A user first registers as a member on Dream 21 site 100 (S 100). At the time of registration, one inputs such things as date of birth etc. This input information is registered in member information data base 101 of storage mechanism 8.

Then a user visits Dream 21 site 100 and begins responding to questions. Initially he or she selects categories and subjects of questions and responses.

Question/response data base 102a is stored in storage mechanism 8. XML files which record questions and responses corresponding to question subjects are distributed for convenience in 3 files in this data base 102a. These XML files describe question texts which have layered XML tags and responses which have the same attached tags as a couple. Hereafter we will refer to these files as question/ response standardized files.

The variable component of questions and input column of responses written in these XML files are replaced by the content that a user inputs, and these XML files are such that they are updated at any time. Thus, these XML files have a file configuration in which question text format storage mechanism 1 and response storage mechanism 3 coexist in one XML file.

Control mechanism 10 selects question texts from this question/response data base 102a one by one, sends them to a user, receives responses to these questions from users, and updates the responses in question/response data base 102a (XML files). By this update processing, the variable components of subsequent questions are determined based on responses received from users and subsequent question texts are generated. Since, by virtue of this, the content of a user's response is reflected in subsequent question texts, it has the effect of counter questioning a user, stimulates a user's reminiscences and relieving a user's tension.

Likewise, control mechanism 10 extracts a chronology of the period corresponding to the question subject that a user selected from chronology database 104. When calculating a period of a question subject, control mechanism 10 refers to the date of birth of the pertinent user registered in member information data base 101 and calculated a period corresponding to the question subject based on this date of birth (S130, S104).

For example, the date of birth of a user is the year 1969, so when the subject is the period of time the person was a new employee of a company, it extracts a chronology of the years around 1992 when this user would have been 23 years old. The chronology extracted is such that the user can view the chronology to refer to it in responding to questions. Control mechanism 10 registers the chronology data extracted in the file of the pertinent user of question/ response data base 102a.

Further, in the questioning process, control mechanism 10 reads data from CSS files and sound file data base 103 in response to a user's response, and alters the design of the display screen which displays on the user's terminal and the BGM which is caused to be played on a user's terminal corresponding to a user's feeling expressed in a response (S105).

When normal questioning corresponding to question subjects and a user's responses to these questions have finished, control mechanism 10 refers to file 105 of XSL (Extensible-Stylesheet-Language) and CSS (Cascading Stylesheet), converts the XML document stored in question/ response data base 102b into page format (S107). This page format data is stored in data base 102b.

A user can access and view the page format data of data base 102b from the home page of Dream 21 site 100 and when a viewer accesses it, response output mechanism 5 sends the response of the person to the user and allows him or her to view it (S108).

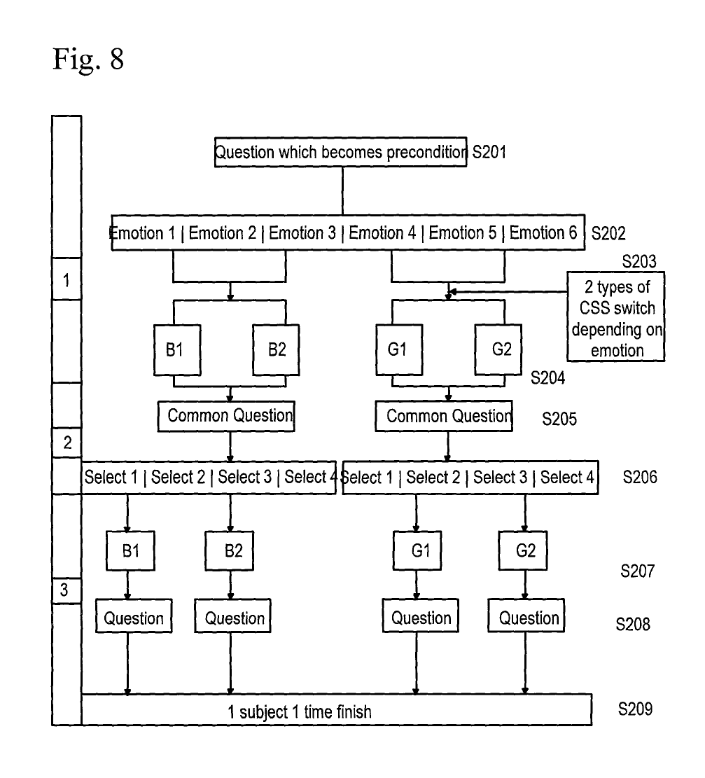

FIG. 8 is a flow chart which illustrates how the previously noted question proceeds. A question for confirming the feelings that a user himself or herself has with respect to a question subject is asked a user at a specified timing (S201). Numerous response options are provided for each emotional level and a user is forced to select a response from among these (S202). Control mechanism 10 selects subsequent question patterns corresponding to the response a user selects, that is to say, corresponding to the feelings of a user with respect to a subject.

In this example, the confirmation of a user's emotional level is performed in two separate stages. In the first stage of confirming emotional level it separates/ branches question patterns into two types of CSS files (XML files) (S203, S204) and in the second stage of confirming emotional level each question pattern is separated/ branched into two additional types (S206, S207). Then it questions a user based on a CSS file (XML file) selected by timing of respective branches (S205, S208).

When normal questions which concern one type of question subject are finished (S209), the same question is repeated twice in this example, so that a user will respond to the same question three times. Incidentally, for responses indicated by a user, when he or she finishes the response of one XML file or after responding to a question for which one performs a free input (a response of the type filling a blank), it is set so that the occasion can be preserved.

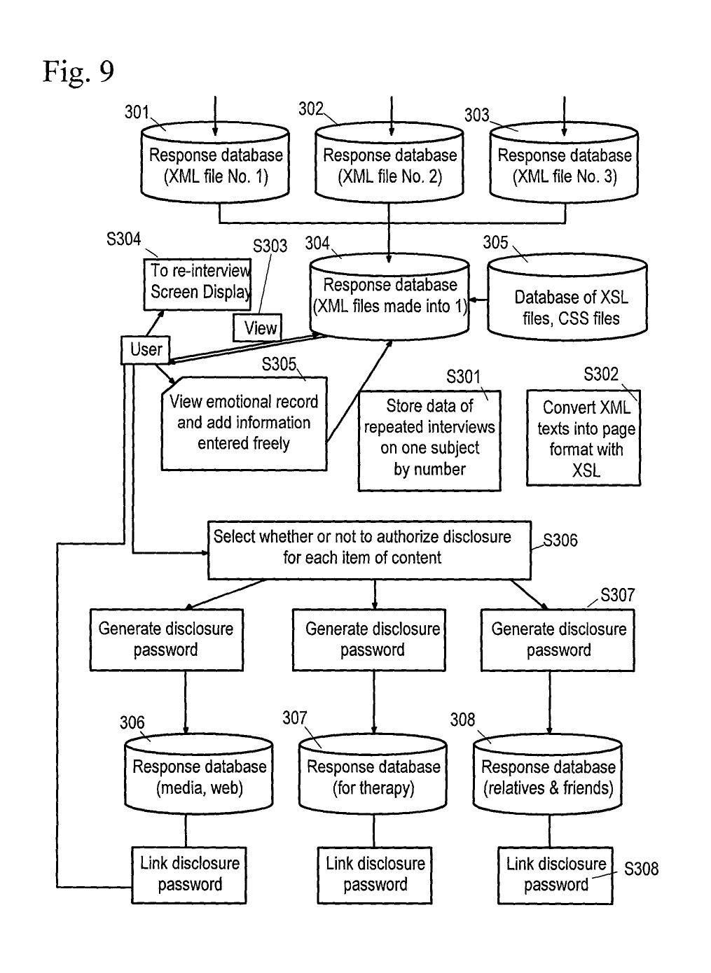

Next, FIG. 9 is a flow chart of when a user outputs the user's response external to that person or to third party other than that person.

The XML files which record the previously noted questions and responses are, for the sake of convenience, distributed to numerous files and stored. (Symbols 301-303)

Control mechanism 10, when a user's responses to question subjects are complete and information that can be output to the outside is in order, links information of the numerous XML files which were distributed, consolidates it in one file and stores in reminiscence data base 304.

A user may repeatedly respond to the same question subject and can store the respective responses by separate file names. Numerous responses to the same question subject are given serial numbers in order based on date and time saved so that they are managed (S 301). Control mechanism 10 refers to database 305 which has stored XSL files and CSS files and converts information stored in response data base 304 into page format information (S302).

A user views the information of response data base 304 which has been converted into page format, and he or she can confirm his or her response (S303). After confirming one's response, one jumps to an interview screen, and responds anew to question subjects, and can modify responses that have already been finished (S304). In addition, it is also possible to grasp one's own emotional history from one's responses in the past which have been organized chronologically. It is also possible to add supplementary information to existing information in response database 304 (S305).

Further, a user may request that one's responses be disclosed to an outside third party, and control mechanism 10 receives authorization of or denial of authorization of disclosure of information in tag units described in XML files, and receives the designation of the portion of the information for each disclosure party (306) In addition, control mechanism 10 accepts passwords for authorizing disclosure of information from users for each party to which the information is to be disclosed.

In addition, it automatically generates passwords to parties to which information is to be disclosed and presents the passwords which are associated with the parties to which information is to be disclosed to a user (S307). Control mechanism extracts only the information authorized for disclosure to the parties which were specified by the user, compiles a response data bases for viewing 306-308, and designates the earlier specified password for each response data base for viewing for each party authorized for disclosure as an access authentication key. A user informs each party authorized for disclosure of information of the corresponding password for viewing.

Each of the parties to which information is to be disclosed, such as news media, medical facilities, relatives, etc., can view the content of the response database within the scope of their authorization, by entering the password they have received from the user and authenticating.

By virtue of this, parties to which information is to be disclosed are allowed to view the emotional history of a given user within the scope that the user has authorized. The privacy of a user is protected and one's personal history is introduced to the world through the media, they can receive appropriate mental health care from medical institutions, and it is useful in care given by relatives.

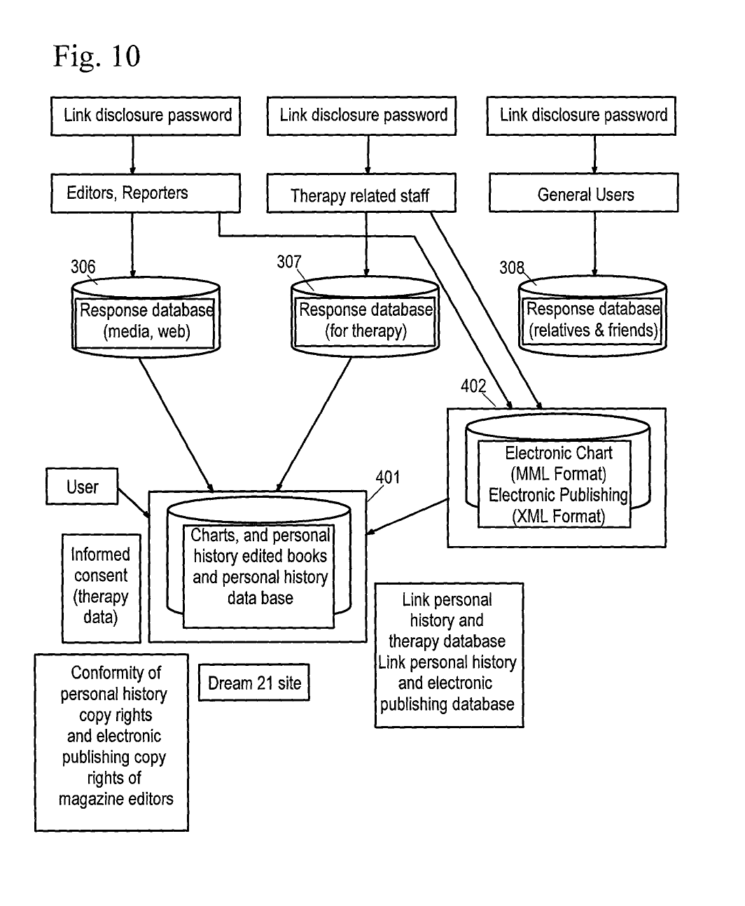

Next FIG. 10 is a flow chart showing the procedure for third parties to view a response database.

Persons such as representatives of the media and medical personnel of medical institutions that have received the passwords for viewing response data bases 306-308, access Dream 21 site 100 and request to view response data bases 306-308. Control mechanism 10 requests the input of a password for viewing via the terminal of the party which has requested to view and which wishes to view (output terminal 400). Control mechanism 10 authenticates the party wishing to view by virtue of a viewing password input by the party wishing to view and authorizes them to view response data bases 306-308.

In addition, control mechanism 10, is outfitted with a feature which imports personal history information stored in response data bases 306-308 to a chart data base (data base for medical use) formed in advance and generates a chart and personal history linked data base 401. Likewise, control mechanism 10 is outfitted with a feature which imports a user's personal history information stored in response data bases 306-308 to a data base for electronic publishing formed in advance and generates edited main data of one's personal history. Here, the electronic chart data and data for electronic publishing is stored respectively in the data bases of medical institutions and data bases of the media 402.

A user can view chart data that links one's personal history and it is possible that it may be put to use with informed consent.

By putting in order and organizing the past reality that a person has experienced and the complex emotional history which flows from it and with which it is complexly intertwined an individual can solve mental or emotional problems with which he is she is presently plagued by himself or herself.

With the use of the invention as explained above, stimulated recollection of the past can be expected. A user who is questioned can relax, due to the fact that he or she is spoken to using the name with which he or she was addressed in the past. The image of past situations will come easily, due to questions incorporating concrete situations that he or she experienced in the past, because the question text generating mechanism applies a prior response which has matching attributes to a variable component of a question text format, completes the question text and displays it on a user terminal 300.

Using the invention, more suitable rehabilitation will be carried out more easily than in the past because such things as the changes of emotions etc. from a user's reminiscences are made into a database. When a physician or caregiver is providing mental health care for a patient, the database can be utilized to easily obtain the patient's past as organized information. Because a complex emotional history that could not be organized in the mind of an individual can be perceived and understood in a more logical format, an individual can organize various things he or she is very particular about, etc., which have accumulated in one's mind, and can better understand themselves. They can expect such things as the relief of stress and prevention of dementia and mental problems.

Moreover, since recollection from user's reminiscences are made into a data base in an XML file, it is easy to extract a response which has specific attributes by specifying an XML tag. Likewise, they can also be easily compiled on charts and forms for publishing personal histories.

Since the response output control mechanism will only disclose responses which a user has authorized to the outside, the will of the user is respected and the privacy of a user can be protected. It can precisely reflect a user's intentions with respect to disclosure of information because whether or not something is to be disclosed can be set precisely by attribute unit of a response.

Likewise, because the question generating mechanism ascertains the emotional level of a user from a user's response and changes subsequent question patterns corresponding to this emotional level, it can appropriately question a user in conformance with the user's emotions and it is possible to stimulate reminiscences without imparting a baleful influence on the feelings of a user.

In addition, since a multimedia linking mechanism links data such as maps, photographs and music etc. related to the response of a user to a user's response, physicians etc. who utilize the data base can make use of these types of information in the care they are providing for a user and it becomes possible to make use of it effectively in the care of the mental health of a patient.

Further, because it becomes possible for patients and their attending physicians and caregivers etc. to build extranets linking telecommunication networks, attending physicians and caregivers can easily send various electronic formats of therapy charts that they have performed on a given patient to a patient's individual data base, it becomes possible for a patient to easily obtain and confirm various types of therapeutic data concerning the patient at any time through Dream 21 site. Since it becomes possible for physicians and caregivers of a patient to mutually disclose data in a timely fashion with an extranet linking patients, physicians and caregivers, it can facilitate such things as informed consent etc. with respect to patients and makes it possible to significantly improve the supporting costs of physicians and care-givers.

The present invention is not restricted here to the previously noted form of embodiment and example of application. It is also possible to install a reminiscence support program in a user's terminal and collect a user's reminiscences in a stand-alone configuration. Likewise, it is also possible within the teachings of the invention to output question texts from a user terminal 300 to a user and accept responses from a user to a user terminal by voice. In this case, voice text conversion software would be incorporated into the user interface of user terminal 300.

Accordingly, it is to be understood that the embodiments of the invention herein described are merely illustrative of the application of the principles of the invention. Reference herein to details of the illustrated embodiments are not intended to limit the scope of the claims, which themselves recite those features regarded as essential to the invention.

### TABLE OF REFERENCE NUMBERS

1 Question text form storing mechanism

2 Telecommunications mechanism

3 Reminiscence storage mechanism

4 Question test generating mechanism

5 Response output mechanism

6 Response output control mechanism

7 Multimedia link mechanism

8 Storage mechanism

10 Control mechanism

100 Reminiscence data base system (Dream 21 site)

200 Telecommunications network (Internet)

300 User terminal

400 Input/Output terminals

500 External sites such as maps etc.

What is claimed is:

1. A reminiscence data base system comprising:
a question database comprising stored question text formats, the question text formats comprising question texts for stimulating or prompting a user's reminiscence and a variable component having attributes;
a response data base comprising stored replies to said question texts together with attributes of said replies;
a question text generating mechanism which reads at least one question text format from said question database, reads responses which match variable component and attributes of the question text format from said response database, and fills the responses in variable components which match attributes of the question text format, generating question texts, and outputs the question texts to said telecommunications mechanism;
a response output mechanism which converts responses from the response databases into a specified format; and
a telecommunications mechanism which outputs question texts from the question database to a user, obtains replies to question texts from said user, and outputs responses from the response output mechanism.

2. The reminiscence data base system of claim 1 wherein said attributes of the question text format are indicated by XML tags, and said response database stores responses as XML files.

3. The reminiscence data base system of claim 1 further comprising a response output control mechanism, which obtains from said user an indication of whether to permit or not permit disclosure of responses stored in said response database, and only passes responses for which disclosure has been authorized to said response output mechanism.

4. The reminiscence data base system of claim 3 wherein said response output control mechanism controls said authorization of whether or not to disclose in attribute units linked to a response.

5. The reminiscence data base system of claim 1 wherein said question text generating mechanism selects differing question text formats corresponding to responses expressing an emotional level of a user from among the responses stored in said response storage mechanism.

6. The reminiscence data base system of claim 1, further comprising a multi-media linking mechanism which stores maps, photographs or the like, corresponding with a response in the response database, in association with attributes of the response.

7. The reminiscence data base system of claim 1 which further comprises
a comment receiving mechanism which receives comments from a party other than said user which has obtained a response output from said response output mechanism, the comments concerning a response, or the person making said response;
a comment database which stores said comment in association with said person making a response; and
said response output mechanism converts said comment in addition to said response into a specified format.

8. A computer readable medium which has recorded a reminiscence support program for the purpose of causing a computer to execute a method comprising the steps of:
a) outputting question texts to a user;
b) obtaining replies to question texts from the user;
c) creating and storing a data base of replies to said question texts together with attributes of said replies;
d) reading question text formats from said question text format storage mechanism, reading responses which match variable components and attributes of this question text format from said response storage mechanism, filling the read responses in variable components which match attributes of question text formats, generating question texts; and
e) repeating the method from step a, using question texts generated in step d.

9. The method of claim 8, in which the steps of outputting question texts and obtaining replies are performed through a telecommunications mechanism.
